(19) United States
(12) Patent Application Publication
(10) Pub. No.: US 2004/0071272 A1
(43) Pub. Date: Apr. 15, 2004

(54) Adapter for use in telephone recording

(76) Inventor: Satoshi Mizuguchi, TOKYO (JP)

Correspondence Address: GREENBLUM & BERNSTEIN, P.L.C., 1950 ROLAND CLARKE PLACE, RESTON, VA, 20191, US

(21) Appl. No.: 10/679,411

(22) Filed: Oct. 7, 2003

(30) Foreign Application Priority Data
Oct. 8, 2002 (JP) 2002-295074

(51) Int. Cl. H04B 10/00; H04M 1/64

(52) U.S. Cl. 379/56.1; 379/56.3; 379/88.13; 379/67.1

(57) ABSTRACT

An adapter for use in telephone recording of picking-up electric voice signals from a telephone set and outputting them to a sound recording apparatus, comprising a photocoupler having a light emission device that converts electric voice signals picked-up from the telephone set into optical signals and a photoreceiving device for converting the optical signals again into the electric voice signals and outputting them to the sound recording apparatus incorporated into a package case, whereby the telephone set and the recording apparatus are electrically isolated from each other to prevent intrusion of noises from the recording apparatus to the telephone circuit and eliminate the worry of giving unpleasant feeling to the calling party or the worry that the calling party may suspect the contents of telephone call are under recording.

### BACKGROUND OF THE INVENTION

1. Field of the Invention

The present invention concerns an adapter for use in telephone recording used for recording the contents of telephone call by a sound recording equipment such as a tape recorder.

2. Statement of Related Art

Recent telephone sets are sometimes equipped with a message recording function of an answering telephone (hereinafter referred to as a message recording function). However, the message recording function involves problems such that it takes a much time till recording of the telephone call after pushing a recording start button, or generates sounds upon pushing the button or upon setting the mechanism, so that a calling party may possibly suspect that the contents of telephone call are under recording, or the continuous recording time is short.

For solving the problem described above, a sound recording apparatus 42 such as a cassette tape recorder as shown in FIG. 4 is marketed, which has a telephone recording adapter 41 for picking-up electric voice signals from a telephone set 40 and outputting them, and has a function of detecting the presence or absence of electric voice signals outputted from the telephone set 40 by way of the adapter 41 to automatically start and stop recording.

When the recording apparatus 42 is used, a plug 46 of a modular cable 45 that connects a hand set 43 of the telephone set 40 and a telephone set main body 44 is disconnected from a modular terminal 47, and inserted into a modular terminal 48 of the telephone recording adapter 41, a plug 50 of a modular cable 49 disposed to the adapter 41 is inserted into the modular terminal 47 of the telephone set main body 44 to pick-up electric voice signals from the telephone set 40, and a plug 52 of a voice output cord 51 disposed to the adapter 41 is inserted into a microphone terminal 53 of the recording apparatus 42 to output the electric voice signals picked up from the telephone set 40 to the recording apparatus 42.

However, in the existent telephone recording adapter 41 shown in FIG. 4, since the electric voice signals picked-up from the telephone set 40 are outputted as they are to the recording apparatus 42, the ground line is used in common with the electric voice signal line of the telephone set 40 and noises on the side of the recording apparatus 42 intrude through the adapter 41 to the telephone circuit to give unpleasant feeling to a calling party or result in a worry that the calling party may possibly suspect that the contents of the telephone call are under recording.

### SUMMARY OF THE INVENTION

In view of the above, the present invention intends to electrically isolate lines between a telephone set and an recording apparatus connected by way of a telephone recording adapter thereby inhibiting noises on the side of the recording apparatus from intruding to the telephone circuit.

The foregoing subject can be solved according to the present invention in an adapter for use in telephone recording of picking-up electric voice signals from a telephone set and outputting them to a sound recording apparatus, comprising a photocoupler having a light emission device that converts electric voice signals picked-up from the telephone set into optical signals and a photoreceiving device for converting the optical signals again into the electric voice signals and outputting them to the sound recording apparatus, the devices being incorporated into a package case.

In the adapter for use in telephone recording according to the present invention, electric voice signals picked-up from the telephone set are once converted into optical signals by the light emitting device of the photo-coupler, and the optical signals are converted again into the electric voice signals by the photoreceiving device of the photocoupler and outputted to the sound recording apparatus. Thus, the circuit for outputting the electric voice signals pick-up from the telephone set to the recording apparatus is electrically isolated between the light emitting device and the photoreceiving device of the photocoupler thereby preventing intrusion of noises from the recording apparatus to the telephone circuit.

### DESCRIPTION OF THE ACCOMPANYING DRAWINGS

Preferred embodiments of this invention will be described in details based on the drawings, wherein

FIG. 1 is an outer view showing an example of an adapter for use in telephone recording according to the present invention;

FIG. 2 is a view showing an embodiment of an electric circuit constituting a main portion of an adapter for use in telephone recording according to the present invention;

FIG. 3 is a view showing another embodiment of an electric circuit constituting a main portion of an adapter for use in telephone recording according to the present invention; and

FIG. 4 is an outer view showing an existent example of an adapter for use in telephone recording and a method of using the same.

### DESCRIPTION OF PREFERRED EMBODIMENTS

Preferred embodiments of the present invention are to be described specifically with reference to the drawings.

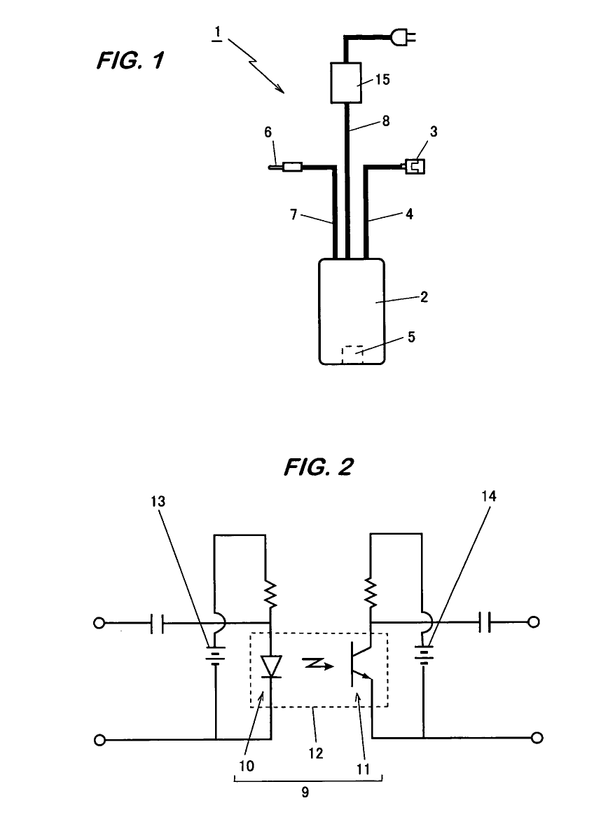

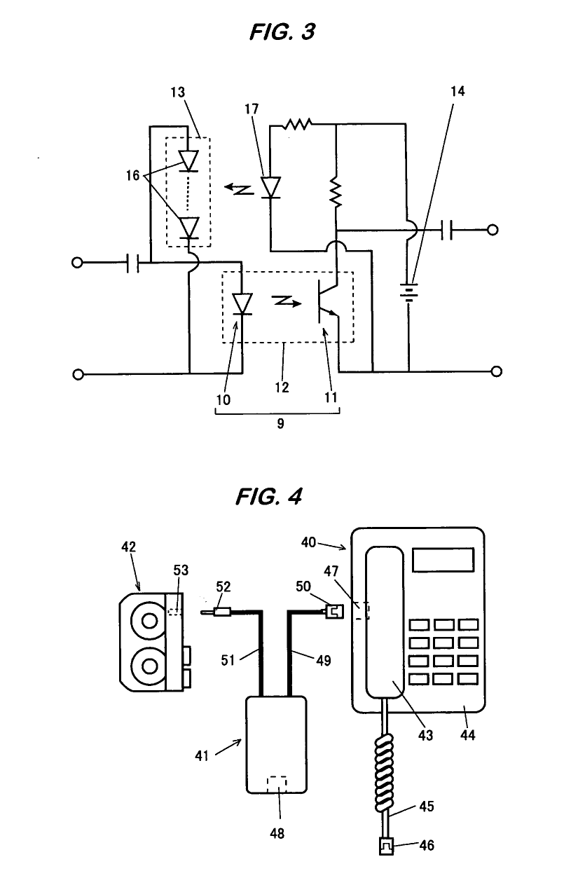

An adapter 1 for use in telephone recording shown in FIG. 1 has a housing case 2 made of a plastic material. To the housing case 1, are attached a modular cable 4 having a modular plug 3 to be connected with a modular terminal 47 of a telephone set 40 shown in FIG. 4, a modular terminal 5 for connection with a modular plug 46 provided to a modular cable 45 of the telephone set 40, a voice output cord 7 having a plug 6 for connection with a microphone terminal 53 of a sound recording apparatus 42 shown in FIG. 4 and a power source cord 8. Further, a photocoupler 9 shown in FIG. 2 and FIG. 3 is incorporated in the housing case 2.

The photocoupler 9 in the housing case 2 comprises a light emission device (light emission diode) 10 for converting electric voice signals inputted from the telephone set 40 by way of the modular cable 45 of the telephone set 40 connected with the modular terminal 5 and the modular cable 4 connected with the modular terminal 47 of the telephone set 40, and a photoreceiving device (phototransistor) for converting the optical signals again into the electric voice signals and outputting them to the voice output cord 7. The light emission device 40 and the photoreceiving device 11 are incorporated in one packaging case 12.

FIG. 2 shows a first bias power source 13 for applying a bias to the light emission device 10 to output optical signals of a waveform similar with an input waveform of the electric voice signals and a second bias power source 14 for applying a DC voltage to the base of the photoreceiving device 11 thereby supplying a DC current for converting the optical signals outputted from the light emission device 10 again into electric signals. The light emission device 10 and the photoreceiving device 11 are connected individually to the first bias power source 13 and the second bias power source 14 respectively which are isolated electrically from each other, so that noises on the recording apparatus 42 do not transmit through the power source circuit to the telephone circuit.

Each of the power sources 13 and 14 in FIG. 2 may be dry cells. However, use of the dry cells causes troublesome exchange of the cells or lead to worry that the adapter 1 may be inactuated by exhaustion of the cells. In addition, the housing case is enlarged by the provision of a cell casing for containing the dry cells, as well as the housing case 2 has to be constituted such that it can open and close so as to enable exchange of the cells, to result in a disadvantage that the fabrication cost is increased.

FIG. 3 shows a power source circuit which is improved for overcoming the disadvantages described above. A bias power source 14 for a photoreceiving device 11 is constituted so as to be supplied from a power source cord 8 connected by way of a DC power supply 15 to AC 100 V, and a bias power source 13 for a light emission device 10 comprises a photovoltaic device 16 such as PHOTOVOL (trade name of product manufactured by Toshiba) for converting light into electric energy. A light emission device 17 for irradiating light to the photovoltaic device 16 to induce electromotive force therein is connected to the bias power source 13 of the photoreceiving device 11 in parallel with the photoreceiving device 11.

With the constitution described above, the bias power sources 13 and 14 are electrically isolated from each other and they are free from the worry of transmission of noises between them. In addition, there is neither troublesome exchange for cells nor worry of cell exhaustion, as well as there is neither requirement for providing a cell case for accommodating dry cells in the housing case 2 nor requirement for opening/closing constitution of the housing case 2 for call exchange, so that the size of the housing case 2 is not enlarged and the fabrication cost is not increased.

The adapter 1 for use in telephone recording has been constituted as described above and description will be made to a series of operations thereof. In the adapter 1 for use in telephone recording having the circuit shown in FIG. 3, when the second bias power source 14 for applying the bias to the photoreceiving device 11 of the photocoupler 9 is supplied from the power source cord 8, the light emission device 17 connected in parallel with the photoreceiving device 11 emits light and the light is irradiated to the photovoltaic device 16 constituting the first bias power source 13, whereby the photovoltaic device 16 generates photovoltaic force to apply a bias to the light emission device 10 of the photocoupler 10.

The electric voice signals picked-up from the telephone set in this state are converted by the light emitting device of the photocoupler 9 into optical signals in proportion with AC signal currents and the optical signals are converted by the photoreceiving device 11 of the photocoupler 9 again into electric voice signals and the electric signals are outputted through the voice output cord 7 to the recording apparatus.

This can record the contents of telephone call reliably by the recording apparatus, as well as the noises caused on the side of the sound recording apparatus upon recording are reliably shut between the light emission device 10 and the photoreceiving device 11 of the photocoupler 9 in a state electrically isolated from each other, so that there is no worry at all that the noises transmit to the telephone circuit giving unpleasant filling to the calling party and that the calling party may suspect that the contents of telephone call are under recording.

According to the present invention, in a case where electric voice signals picked-up from the telephone set by the adapter for use in telephone recording, since intrusion of noises caused on the side of the recording apparatus to the telephone circuit of the telephone set by way of the adapter for use in telephone recording can reliably be prevented, it can provide an excellent effect of overcoming the worry of giving unpleasant feeling to the calling party or the worry that the calling party may suspect that the contents of telephone cord are under recording by the noises.

The present disclosure relates to subject matter contained in priority Japanese Patent Application No.2002-295,074 filed on Oct. 8, 2002, the contents of which is herein expressly incorporated by reference in its entirety.

What is claimed is:

1. An adapter for use in telephone recording of picking-up electric voice signals from a telephone set and outputting them to a sound recording apparatus, comprising a photocoupler (9) having a light emission device (10) that converts electric voice signals picked-up from the telephone set into optical signals and a photoreceiving (11) device for converting the optical signals again into electric voice signals and outputting them to the sound recording apparatus, the devices being incorporated into a package case (12).

2. An adapter for use in telephone recording according to claim 1, wherein the light emission device (10) and the photoreceiving device (11) are connected individually to the first bias power source (13) and the second bias power source (14), respectively, which are isolated electrically from each other.

3. An adapter for use in telephone recording according to claim 2, wherein the first bias power source (13) connected to the light emission device (10) comprises a photovoltaic device (16) for converting a light into electric energy and a light emission device (17) for irradiating light to the photovoltaic device (16) thereby causing photovoltaic force therein is connected in parallel with the photoreceiving device (11) to the second bias power source (14) connected to the photoreceiving device (11).
